(19) United States
(12) Patent Application Publication
(10) Pub. No.: US 2024/0247384 A1
(43) Pub. Date: Jul. 25, 2024

(54) GAS DIFFUSION LAYER FOR AN ELECTROCHEMICAL CELL AND ELECTROCHEMICAL CELL

(71) Applicant: Siemens Energy Global GmbH & Co. KG, München (DE)

(72) Inventors: Simon Kießlich, Erlangen (DE); Alexander Spies, Kemnath (DE)

(21) Appl. No.: 18/564,195

(22) PCT Filed: Mar. 23, 2022
(86) PCT No.: PCT/EP2022/057598

§ 371 Date: Nov. 27, 2023

(30) Foreign Application Priority Data
May 31, 2021 (EP) 21176920.3

(51) Int. Cl. C25B 11/032; C25B 11/036; H01M 8/0232; H01M 8/0254; H01M 8/0258

(52) U.S. Cl. CPC C25B 11/032; C25B 11/036; H01M 8/0232; H01M 8/0254; H01M 8/0258

(57) ABSTRACT

The invention relates to a gas diffusion layer for an electrochemical cell, having a contacting unit and a metal unit which is arranged at or on the contacting unit. With respect to a main surface with a defined thickness (d), the metal unit has a plurality of projections which are substantially perpendicular to the main surface. At least one opening is formed on at least one side surface or top surface of the plurality of projections of the metal unit. Each elongation of the plurality of projections is at least three times the thickness (d) of the metal unit.

### BACKGROUND

The invention relates to a gas diffusion layer for an electrochemical cell and to an electrochemical cell. The electrochemical cell may, for example, be a fuel cell or electrolysis cell.

In electrolysis cells, for example a PEM electrolysis cell, gas diffusion layers are frequently used within the cell. The gas diffusion layer fulfills various functions. Firstly, electrical contact-connection of a membrane to a bipolar plate is to be enabled. In addition, process media formed, for example hydrogen or oxygen, are to be led off reliably. Other process media, for example water, are to be fed in at the same time. Therefore, a gas diffusion layer, as well as a certain porosity, must also have mechanical, electrical and topological properties that can fulfill the aforementioned functions.

Gas diffusion layers of this kind do exist, but are usually very costly. In the case of sintered sheets, for example, a graduated surface is usually needed. For this purpose, it is frequently the case that powders are compressed together, sintered and/or fused to one another. This is an attempt to optimize a size or property of the sintered sheet for the gas diffusion layer. It is frequently the case that a complex thermal treatment is needed to produce a suitable gas diffusion layer. Because of this complexity, there is a need for a more efficient and in particular less expensive means of production of a gas diffusion layer. Electrolysis cells of this kind are not yet designed for a larger scale. What this means is more particularly that such electrolysis cells should provide powers in the kilowatt or megawatt range. Specifically in the case of electrolysis cells that are to be suitable for aviation, for example, such electrolysis cells rapidly take on corresponding dimensions. Specifically in the high-performance sector, the aspect of economic viability moves to the forefront in the case of electrolysis cells. In order to be able to viably operate such electrolysis cells too, especially PEM electrolysis cells (PEM=proton exchange membrane), there will have to be a distinct drop in the purchase price per kilowatt of power. For this purpose, it is necessary to keep an eye on a potential reduction in costs in all necessary components. This is barely possible with the currently existing structures.

### SUMMARY

Embodiments include a gas diffusion layer for an electrochemical cell, having a contacting unit and a metal unit which is arranged at or on the contacting unit. With respect to a main surface with a defined thickness (d), the metal unit has a plurality of projections which are substantially perpendicular to the main surface. At least one opening is formed on at least one side surface or top surface of the plurality of projections of the metal unit. Each elongation of the plurality of projections is at least three times the thickness (d) of the metal unit.

### BRIEF DESCRIPTION OF THE DRAWINGS

The drawings represent illustrative embodiments of the invention. However, the invention is not limited to the working examples shown in the figures. The figures show:

FIG. 1: a schematic view of a gas diffusion layer with metal unit and contact-connection component in cross section;

FIG. 2: an illustrative degressive spring characteristic for the gas diffusion layer;

FIG. 3: an illustrative metal unit with slot bridge perforation;

FIG. 4: a beveled perforated sheet as metal unit;

FIG. 5: a schematic diagram of an electrochemical cell together with the gas diffusion layer.

### DETAILED DESCRIPTION

One object of the invention can be considered that of producing components for electrochemical cells in a more economically viable manner. In particular, high-performance electrochemical cells are to be producible at lower cost, or the economic viability thereof is to be increased. This problem is addressed by this invention with the independent claims of this application. Alternative and viable embodiments are specified in the dependent claims, the description and the figures.

The invention envisages a gas diffusion layer for an electrochemical cell, having a contact-connection unit and a metal unit. The metal unit is disposed against or on the contact-connection unit. In particular, the metal unit may be disposed directly against or on the contact-connection unit. The metal unit, with respect to a flat base level of defined thickness, has a multitude of elevations essentially at right angles to the base level. The flat base level may be part of the metal unit. The metal unit may thus have been formed from the flat base level. The metal unit may be a stamped and/or embossed sheet.

However, it is also possible that the flat base level is a projected plane in a normal direction. In the case of a corrugated, v-shaped or w-shaped metal plate, for example, a flat contact area, for example a flat table surface, may represent the flat base level. In such a case, the flat base level is not part of the metal unit. In one embodiment, the flat base level is part of the metal unit. The metal unit may thus include the flat base level or includes the flat base level.

The metal unit, especially with regard to the flat base level of defined thickness, especially includes a multitude of elevations essentially at right angles to the base level. The expression “essentially at right angles” here may mean that variances from 90° are also possible. “Essentially at right angles” may especially mean an angle of 75° to 110° of the respective elevation relative to the base level.

At least one opening is formed on at least one lateral face or top face of the multitude of elevations of the metal unit. A respective elevation of the multitude of elevations is especially at least three times the thickness of the metal unit. The respective elevation of the multitude of elevations at right angles to the metal unit or at right angles to the flat base level is at least three times the thickness of the metal unit. In one embodiment, the respective elevation is a perpendicular margin, perpendicular distance, perpendicular height or a perpendicular measure of the elevation from the base level or the metal unit. The elevation may also have a longitudinal extent and a transverse extent. The longitudinal extent is especially an extent of the elevation parallel to the base level. The transverse extent is especially likewise an extent of the elevation parallel to the base level, but at right angles to the longitudinal extent. In one embodiment, the respective elevation of the multitude of elevations is a perpendicular distance of the elevation from the flat base level of the metal unit or a perpendicular projecting measure of the respective elevation from the flat base level of the metal unit.

The opening may be a bore or a hole. The opening may take the form of a recess that enables passage of gas through the metal unit. In particular, the opening or the multitude of openings may allow transport of gas from a first side of the metal unit to an opposite second side of the metal unit. The respective extent of the multitude of elevations may be four times, five times, six times, seven times, eight times, nine times or more than ten times the thickness of the metal unit. In one embodiment, the thickness of the metal unit is based on the flat base level of the metal unit.

The metal unit may take the form of a metal sheet. In particular, the metal unit may take the form of a semifinished product. A semifinished product may especially mean a precursor material, which may be a prefabricated raw material, workpiece or semifinished good. Simple profiles, bars, tubes, plates or metal sheets may be regarded as a semifinished product. Such semifinished product variants may each take the form of the metal unit. The metal unit may, for example, be a sheet having a thickness of 1 to 5 mm.

The openings especially result from the at least one elevation. The opening may be disposed on a lateral face of this elevation and/or on a front face of this elevation. It is thus possible to influence permeability normal to the plane of the sheet. Preference is given to using a sheet as metal unit since this is particularly inexpensive. In one embodiment, the at least one elevation is a slot bridge perforation. A metal sheet with slot bridge perforation can be obtained, for example, by a stamping process. The contact-connection layer is especially disposed on the side of the metal unit remote from the elevations. It is thus possible to inexpensively create a gas diffusion layer for an electrochemical cell.

In an additional or alternative embodiment, an arrangement of the multitude of elevations and the respective extents thereof are defined such that the metal unit together with the contact-connection unit forms a spring component having a degressive spring characteristic. The arrangement of the multitude of elevations and the respective extents thereof may especially include a number and position of the corresponding openings. In particular, the elevations are not separated from the metal unit by the openings. For example, the elevations may be cylindrical, triangular or cuboidal. Also possible is a mixture of different geometric shapes with regard to the elevations. The respective arrangement and extent of the elevations including the corresponding openings may be ascertained in advance by means of a finite element method. Slot bridge perforation has been found to be particularly efficient here. At the same time, slot bridge perforation can be produced inexpensively. Slot bridge perforation may especially feature an elongated elevation. It may be described as an alternating zip fastener pattern. Each slot bridge is raised up from a base level of the metal sheet. At the same time, there is an opening in the region of the slot bridge perforation that enables transport of gas through the metal unit. In one embodiment, the arrangement and the respective extent of the elevations may be defined such that a minimal amount of offcut from the metal unit is formed in production of the gas diffusion layer. Therefore, preference is given to using a stamping process since no offcut material is formed here.

An additional or alternative embodiment relates to a gas diffusion layer, wherein all respective elevations have essentially the same extent. What may be meant more particularly by “essentially the same extent” is that the smallest elevation differs by not more than 10% from the largest elevation. In this case, the respectively largest elevation is used as reference parameter. At the same time, it is the case here that the respective elevations are in an equivalent, regular and/or homogeneous arrangement. The arrangement of the multitude of elevations thus especially corresponds to a regular pattern. This is particularly advantageous since such elevations are implementable by means of simple manufacturing processes, for example stamping processes. A stamped metal plate or a stamped metal sheet may thus be formed to a metal unit having regular elevations. The elevations thus formed especially correspond to a stamped profile used in a stamping machine. It is thus possible in a particularly simple manner to create a corresponding metal unit.

In an additional or alternative embodiment, an arrangement and/or extent of the elevations relating to a distance of the elevations from one another, a characteristic of the elevation, the extent of the elevation is determined as a function of a defined parameter of the gas diffusion layer, especially a cell thickness and/or contact pressure of the gas diffusion layer. The extent of the elevation may be regarded as a height of the elevation. By means of a correspondingly higher elevation, it is possible to adjust a cell thickness of the gas diffusion layer. It is likewise possible to adjust a contact pressure and the distribution of the contact pressure by means of the arrangement and/or extents of the elevations. The elevations are defined with regard to their arrangement and/or extents so as to result in a homogeneous contact pressure in the gas diffusion layer. By means of an adjustment of the geometry in relation to the separation and characteristics of the elevations, it is possible to accurately establish different cell thicknesses and homogeneity of the contact pressure even in the case of a low level of contact pressure. It is likewise possible to influence porosity of the gas diffusion layer and hence mass transfer. It is thus possible with the aid of the stamping process, in a simple and controlled manner, to influence important parameters, for instance the homogeneity of contact pressure, and the porosity and cell thickness of the gas diffusion layer. In the case of ascertainment of the arrangement and extents of the multitude of elevations, it is possible to use a simulation or a finite element method. By simple and inexpensive methods, it is thus possible to provide a less expensive and nevertheless efficient gas diffusion layer.

In an additional or alternative embodiment, the multitude of elevations and the metal units are monolithic. The multitude of elevations are especially not separate components. In one embodiment, the elevations are made from the same material as the metal unit. The multitude of elevations and the metal unit thus especially form a uniform or one-piece component. The multitude of elevations and the metal unit may thus be regarded as a single component or single unit. Even when openings are disposed on a top face or the lateral face of the elevations, the multitude of elevations and the metal unit may nevertheless be monolithic. In this case, they are made from the same material or consist of the same material. It is thus possible to provide a single metal unit including the corresponding elevations.

In an additional or alternative embodiment, the contact-connection unit takes the form of a nonwoven fabric, metal weave and/or carbon paper, and/or the metal unit takes the form of a sheet, metal foam, metal weave, perforated plate and/or slot bridge-perforated sheet. The contact-connection unit serves in particular for uniform contact connection of the gas diffusion layer to further components of an electrochemical cell. This may be, for example, an electrode, a bipolar plate or a membrane. The metal unit in the form of the sheet may have a multitude of holes. In one embodiment, the metal unit is a metal plate having slot bridge perforation. By means of slot bridge perforation, it is possible to easily and effectively increase a porosity of the metal unit. The porosity may especially be a quotient of the perpendicular extent of the elevation from the metal unit to a total extent of the metal unit in perpendicular direction. If, for example, a 1 mm-thick metal plate has a perpendicular elevation by a further 4 mm, the porosity in this case would be P=4 mm/5 mm=0.8≙80%. A metal sheet stamped in this way corresponds to a porosity of 80% in the context of this application. With the aid of slot bridge perforation, it is possible to adjust the porosity of the metal unit in a particularly simple and inexpensive manner. For instance, it is possible to inexpensively produce a component for electrochemical cells.

In an additional or alternative embodiment, the metal unit has a porosity of at least 80%, which is formed by the multitude of elevations in the metal unit. A higher porosity can be achieved, for example, by a greater extent of the elevations perpendicular to the metal unit. It is thus possible to create larger elevations by means of correspondingly deeper stamping. It is thus possible to increase the porosity of the metal unit and hence the gas diffusion layer.

The invention likewise relates to an electrochemical cell having a gas diffusion layer. For this purpose, the electrochemical cell may have a bipolar plate and an electrode. The gas diffusion layer is contact-connected here to the bipolar plate on a first side and to the electrode on an opposite second side. The electrode may in turn be contact-connected to a membrane. Accordingly, the electrochemical cell may have a membrane. The electrochemical cell may be designed as an electrolysis cell or as a fuel cell. Because of the easily produced gas diffusion layer, it is thus possible to provide an inexpensive and simultaneously efficient electrochemical cell.

In an additional or alternative embodiment, the gas diffusion layer is force-fittingly, form-fittingly and/or cohesively bonded to the bipolar plate and/or the electrode. It is thus possible for the gas diffusion layer to be bonded to the bipolar plate and to the electrode in a wide variety of different ways. The bond may be of the force-fitting, form-fitting and/or cohesive type. Force-fitting bonding may be the result, for example, of placing the respective layers one on top of another and pressing. Form-fitting bonding may be the result, for example, of ensheathing with a metal weave and subsequent pressing. A cohesive bond can be created by welding the respective components. The types of bond mentioned may also exist between the gas diffusion layer and the membrane. Since the gas diffusion layer described can be produced much more easily and less expensively, this advantage is accordingly applicable to the electrochemical cell. It is thus possible to create an electrochemical cell which is much less expensive than before. This may be helpful in implementing the energy transformation.

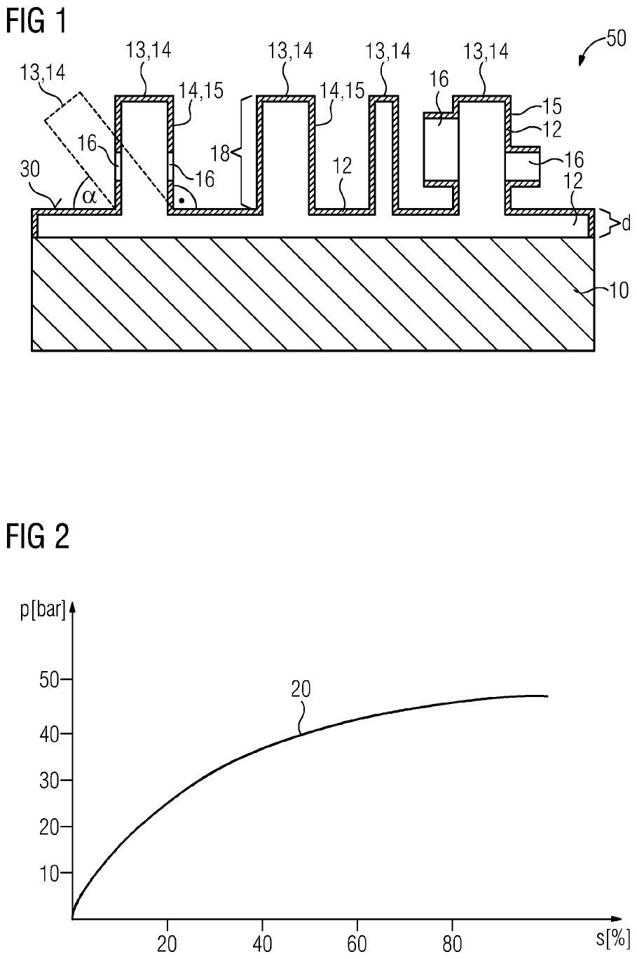

FIG. 1 shows an illustrative gas diffusion layer 50 in cross section. Several components of the gas diffusion layer 50 are apparent. In the lower region, the contact-connection unit 10 is apparent. Above this contact-connection unit 10, the metal unit 12 adjoins a corresponding flat base level 30. The metal unit 12 has a thickness d.

In FIG. 1, perpendicular elevations 14 from the metal unit 12 are apparent. These elevations 14 each have lateral faces 15 and top faces 13. In one embodiment, openings 16 are present or disposed in the region of the lateral faces 15 and top faces 13. A respective extent 18 of these elevations 14 is greater than the thickness d of the metal unit 12. The extent 18 may exceed the thickness d of the metal unit 12 at least by three times, four times, five times, six times, seven times, eight times, nine times or ten times.

In the example of FIG. 1, the multitude of elevations 14 are columnar. However, the elevations 14 may also form an angle α to the base level 30 of the metal unit 12. In particular, the angle adopted may be an oblique angle α. Indicated by dashes in the left-hand region of FIG. 1 is an oblique elevation 14. However, preference is given to using perpendicular elevations 14. Perpendicular may also mean “essentially perpendicular”, which may in turn include an angle of 75° to 110°. FIG. 1 indicates an oblique angle α. However, this oblique angle corresponds to a perpendicular, which is indicated in FIG. 1 in the left-hand elevation 14.

One elevation 14 may have one or more openings 16. These openings 16 are especially on the lateral faces 15 of the elevations 14 and/or on the top face 13 of the elevations 14. It is likewise possible that all elevations 14 have openings 16. In one embodiment, the openings 16 are disposed on respective lateral faces 15 of the elevations 14. However, the openings 16 may also be disposed on the top face 13 of the elevation 14. The top face 13 of the respective elevation 14 is especially remote from the metal unit 12. The openings 16 that can be seen in FIG. 1 are each disposed on the lateral faces 15 of the elevations 14. The top face 13 of the elevation 14 follows on in perpendicular direction relative to the base level 30 of the metal unit 12.

A core concept of this invention is the use of a structure in which bridges, lands, semicircles or similar elevations are punched and embossed from the sheet in a manufacturing step. In one embodiment, these elevations are not separated from the sheet 12. It is thus possible for the elevations 14 shown in FIG. 1 to take the form of bridges, lands, semicircles or similar elevations. The openings 16 enable mass transfer or gas transfer from one side of the sheet 12 to an opposite side of the sheet 12. The first side of the metal unit 12 is disposed on the contact-connection element 10 in FIG. 1.

The second side of the metal unit 12 includes the multitude of elevations 14. The gas diffusion layer 50 shown in FIG. 1 is especially formed by a stamping process. This does not give rise to any offcut material, which can lead to corresponding cost benefits. Preference is given to using a slot bridge perforation. The shape and arrangement of the multitude of elevations 14 can also be created by stud perforation or slot arc perforation. This can create a porous and electrically conductive layer with mechanical spring characteristics.

By means of an adjustment in geometry in relation to the separation and characteristics of the elevations 14, it is possible to accurately establish different cell thicknesses and homogeneity of contact pressure even when the latter is at a low level. In this way, it is possible to easily and specifically influence the porosity of the metal unit 12 or the gas diffusion layer 50 and hence the possibility of mass transfer. An altered pressure level in the region of the gas diffusion layer 50 may give rise to larger or smaller gas bubbles as a result. The porosity of the metal unit 12 and of the gas diffusion layer 50 may especially be dependent on defined pressure conditions in electrochemical cells. It is thus possible for an extent, arrangement and/or shape of the multitude of elevations 14 to depend on an operating pressure of an electrochemical cell 90.

In the case of a conventional perforated sheet as metal unit 12, mass transfer normal to the plane of the sheet is already possible. In order to establish corresponding porosity of the perforated sheet, the perforated sheet is embossed or deep-drawn without separating the structure of the perforated sheet. It is thus possible to enable porosity with regard to the transport of the process media parallel to the plane of the sheet. This is possible, for example, by regular mutual beveling or by means of corrugated embossing of the sheet. Such a process may be chosen if punching is not to be or cannot be used.

Use of the structure described in FIG. 1 as gas diffusion layer 50 or gas diffusion electrode is conceivable, but it is more likely that these structures will be used as spring layer of a composite gas diffusion layer component.

FIG. 2 shows, in this context, by way of example, a degressive spring characteristic 20. The gas diffusion layer 50 especially has the property of the degressive spring characteristic 20. A spring travel is shown by s on an x axis, and a pressure by p on the y axis. It is clearly apparent that there is barely any change in spring travel s with increasing pressure p. In one embodiment, the gas diffusion layer 50 has spring characteristics corresponding to the degressive spring characteristic 20. What this means more particularly is that the gas diffusion layer 50 softens under conditions of increasing pressure p. The degressive spring characteristic 20 is based in particular on the metal unit 12. In this case, the metal unit 12 may also be referred to as spring layer. It is possible here for the spring layer with the corresponding porosity to be combined with a nonwoven fabric.

The nonwoven fabric is especially the contact-connection unit 10. The contact-connection unit 10 may take the form of a nonwoven fabric, carbon paper, metal foam, perforated sheet, metal weave and/or of a finely configurable structure for contact connection of the electrode or membrane. These contact structures mentioned may be force-fittingly, form-fittingly and/or cohesively bonded to the metal unit 12 in an electrochemical cell 90. It is thus possible for the contact-connection unit 10 to be force-fittingly, form-fittingly and/or cohesively bonded to the metal unit 12. The same may apply to bonding of the gas diffusion layer 50 to further components of the electrochemical cell 90, for example the bipolar plate or the electrode or the membrane. The electrochemical cell 90 may be a fuel cell 90 or an electrolysis cell 90.

Because of the simplified structure of the gas diffusion layer 50, cost benefits arise in the respective production thereof because of a smaller number of process steps. An expanded sheet metal composite composed of multiple plies, for example, has to be bonded in many steps. It is thus possible to distinctly reduce a number of process steps in the case of a gas diffusion layer 50 shown by way of example in FIG. 1.

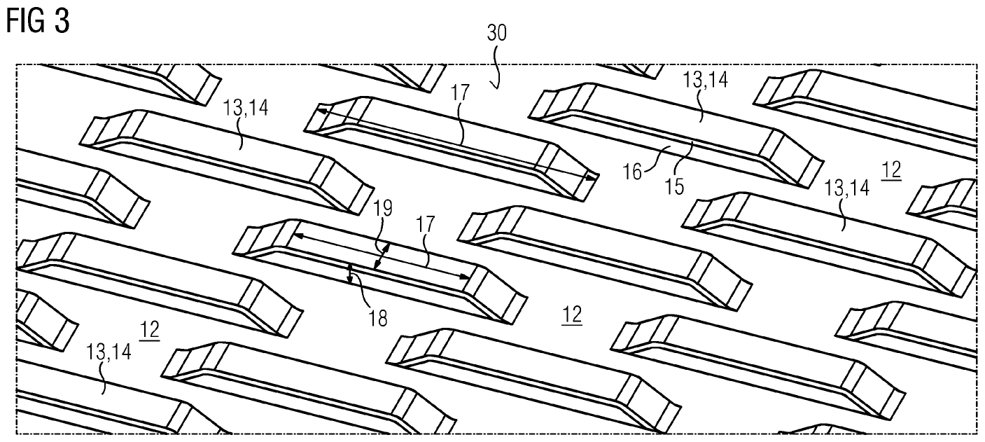

FIG. 3 shows, by way of example, a metal unit 12 with a slot bridge perforation. The multitude of elevations 14 that project perpendicularly from the base level 30 are clearly apparent. The perpendicular elevations 14 have a longitudinal extent 17 and a transverse extent 19 on the top face 13. In the example of FIG. 3, the longitudinal extent 17 is larger than the transverse extent 19. In the example of the slot bridge perforation of FIG. 3, longitudinal extent 17 may mean a maximum longitudinal extent and/or a length in the case of a corresponding extent of the elevation 14. The extent 18 of the multitude of elevations 14 denotes a measure of the perpendicular elevation 14. At the same time, openings 16 are disposed in each case in the region of the lateral faces 15 of the multitude of elevations 14. However, these openings 16 are difficult to see in FIG. 3. Nevertheless, they are present.

The multitude of elevations 14 shown in FIG. 3 constitute a kind of zip fastening pattern. In principle, the multitude of elevations 14 may differ from one another with regard to their arrangement, size and/or extent. However, preference is given to choosing a uniform or homogeneous structure with regard to the multitude of elevations 14 in order thus to create an efficient gas diffusion layer 50 at minimum cost.

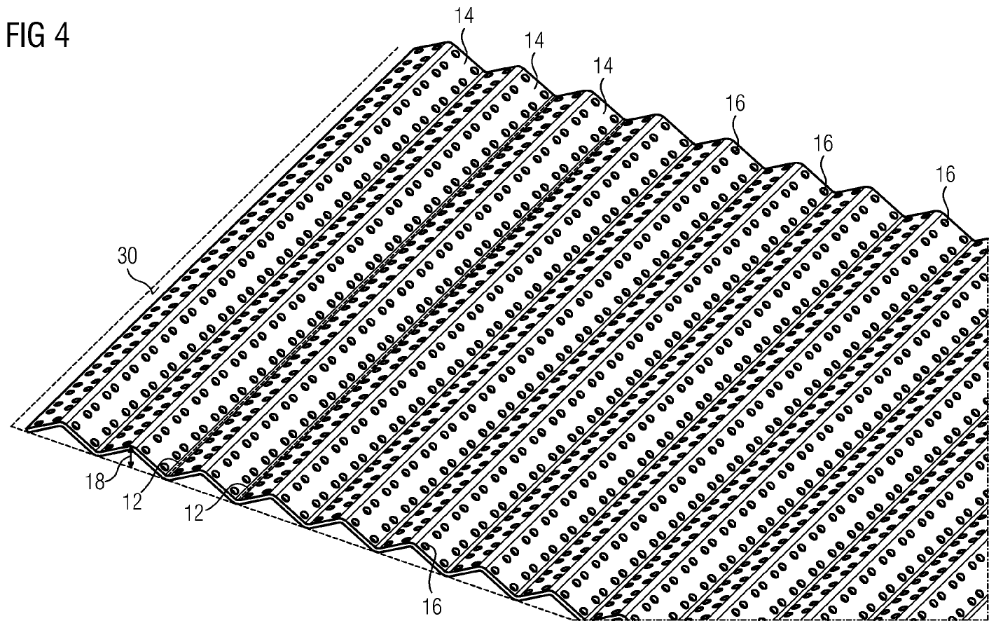

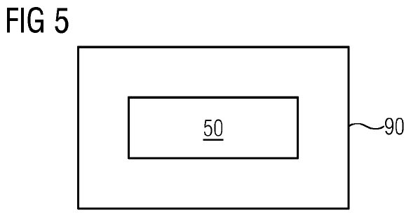

An alternative embodiment for the metal unit 12 of the gas diffusion layer 50 is shown by FIG. 4. The metal unit 12 here takes the form of a beveled perforated sheet. The flat base level 30 is effectively no longer present in FIG. 4. The beveled perforated sheet results from forming of a flat metal plate 12 as an imaginary base level 30 for the example in FIG. 4. This previously flat metal plate 12 is indicated schematically in FIG. 4. Because of this deformation, in the case of FIG. 4, the result is a V-shaped or corrugated pattern with regard to the metal plate 12. The beveled perforated sheet 12 shown in FIG. 4 can be described by a repeating V profile.

Those edges of the V that are disposed in the lower region at the indicated base level 30 correspond to the metal unit 12. This is indicated by a dashed line in FIG. 4. The metal unit 12 in the case of FIG. 4 consists of a multitude of mutually parallel lines. The remainder of the beveled perforated sheet corresponds to the multitude of elevations 14. The example in FIG. 4 is an extreme case of FIG. 3. The metal unit 12 in the example of FIG. 4 includes merely a plurality of lines that are in contact with the originally flat perforated sheet. The remainder of the beveled perforated sheet in the case of FIG. 4 is represented by the multitude of elevations 14.

In one embodiment, a height of this plurality of elevations 14 (V-shaped elevation) is at least three times a thickness of the original perforated sheet. That region of the beveled perforated sheet that rises up from the original plane of the perforated sheet can thus be counted as part of the elevation 14. It may be the case here that a minimum level of elevation 14 must be present in order to enable simpler or better assignment of the beveled perforated sheet to the elevation 14 or to the metal unit 12. As is clearly apparent in FIG. 4, the V profiles, i.e. the plurality of elevations 14, include numerous openings 16. It is thus possible to enable corresponding exchange of gas.

FIG. 5 shows, by way of example and in a schematic diagram, the electrochemical cell 90 together with the gas diffusion layer 50. The electrochemical cell 90 may be designed as a fuel cell 90 or as an electrolysis cell 90. By virtue of the gas diffusion layer 50 shown here, it is possible to achieve low specific costs per square meter compared to existing products for the same function. This results more particularly from easier manufacture or a combination of simple individual parts. At the same time, the gas diffusion layer 50 enables easy adjustment to technical requirements of new cell generations. This can be effected by simple corresponding adjustments of geometry. Depending on the requirement, it is possible, for example, to choose a corresponding new stamping profile for a new geometry. This new stamping profile can be used correspondingly in a manufacturing process for production of corresponding adjusted metal units 12. The production or use of the metal units 12 described here is also readily implementable for large cell areas in the square-meter range. It is possible here to achieve improved tolerance compensation capacity. This likewise gives rise to the possibility of use of elastoplastic spring characteristics in the gas diffusion layer 50 or the electrochemical cell 90.

1. A gas diffusion layer for an electrochemical cell, having
a contact-connection unit and
a metal unit disposed against or on the contact-connection unit, wherein
the metal unit, with respect to a flat base level of defined thickness, has a multitude of elevations essentially at right angles to the base level,
at least one opening is formed on at least one lateral face or top face of the multitude of elevations of the metal unit, and
a respective extent of the multitude of elevations at right angles to the metal unit or at right angles to the flat base level is at least three times the thickness of the metal unit.

2. The gas diffusion layer as claimed in claim 1, wherein an arrangement of the multitude of elevations and their respective extents are determined such that the metal unit together with the contact-connection unit forms a spring component having a degressive spring characteristic.

3. The gas diffusion layer as claimed in claim 1, wherein all respective elevations have essentially the same extent.

4. The gas diffusion layer as claimed in claim 1, wherein an arrangement and/or extent of the elevations relating to a distance of the elevations from one another, a characteristic of the elevation, the extent of the elevation is determined as a function of a defined parameter of the gas diffusion layer, especially a cell thickness and/or contact pressure of the gas diffusion layer.

5. The gas diffusion layer as claimed in claim 1, wherein the multitude of elevations and the metal unit are monolithic.

6. The gas diffusion layer as claimed in claim 1, wherein the contact-connection layer takes the form of a nonwoven fabric and/or the metal unit takes the form of a sheet, metal foam, metal weave, perforated plate and/or slot bridge-perforated sheet.

7. The gas diffusion layer as claimed in claim 1, wherein the metal unit is a metal plate having slot bridge perforation.

8. The gas diffusion layer as claimed in claim 1, wherein the metal unit has a porosity of at least 80% formed by the multitude of elevations of the metal unit.

9. An electrochemical cell having a gas diffusion layer as claimed in claim 1, further comprising:
a bipolar plate,
an electrode, wherein the gas diffusion layer makes contact with the bipolar plate on a first side and with the electrode on an opposite second side.

10. The electrochemical cell as claimed in claim 9, wherein the gas diffusion layer is force-fittingly, form-fittingly and/or cohesively bonded to the bipolar plate and/or the electrode.
